(19) United States
(12) Patent Application Publication
(10) Pub. No.: US 2025/0392086 A1
(43) Pub. Date: Dec. 25, 2025

(54) ELECTRICALLY CONDUCTIVE CONNECTING ASSEMBLY OF A CHRISTMAS TREE TRUNK

(71) Applicants: Winners Group Industries Company Limited, Guigang City (CN); Winner Industry Company Limited, Dongguan City (CN)

(72) Inventor: Junhao CAI, Dongguan (CN)

(21) Appl. No.: 18/996,936

(22) PCT Filed: Oct. 24, 2024
(86) PCT No.: PCT/CN2024/126921

§ 371 Date: Jan. 17, 2025

(30) Foreign Application Priority Data
Aug. 28, 2023 (CN) 202322322283.9

(51) Int. Cl. H01R 13/73; A47G 33/06

(52) U.S. Cl. CPC H01R 13/73; A47G 33/06

(57) ABSTRACT

An electrically conductive connecting assembly of a Christmas tree trunk, which includes: an upper trunk, where a first receiving slot is provided in a bottom end of the upper trunk along a length direction of the upper trunk; a lower trunk, where a second receiving slot configured to detachably accommodate the bottom end of the upper trunk is provided in a top end of the lower trunk along a length direction of the lower trunk; a first electrically conductive head provided in the first receiving slot of the upper trunk; a second electrically conductive head provided in the second receiving slot of the lower trunks. When the bottom end of the upper trunk is inserted in the second receiving slot, the first electrically conductive head is electrically connected to the second electrically conductive head.

### CROSS-REFERENCE TO RELATED APPLICATIONS

This application claims priority to PCT Application No. PCT/CN2024/126921 filed on Oct. 24, 2024, which claims priority to Chinese Patent Application No. 202322322283.9 filed on Aug. 28, 2023, the entire contents of both of which are hereby incorporated by reference.

### FIELD OF TECHNOLOGY

The present application relates to the technical field of Christmas trees, and in particular to an electrically conductive connecting assembly of a Christmas tree trunk.

### BACKGROUND

Christmas tree is an evergreen tree such as a fir or a pine decorated with lights. Christmas tree is one of the most important elements of Christmas. The evergreen tree is usually brought into a house or displayed outdoors before Christmas and decorated with colored lights and ribbons hung on its branches.

At present, in order to facilitate adjustment and transportation, a trunk of a Christmas tree on market is detachable. For example, an upper trunk (the upper trunk is used as a top end of the Christmas tree) is detachably connected to a lower trunk (as a supporting bottom end of the Christmas tree). However, an electrically conductive connection between the upper trunk and the lower trunk is depended on a wire connection. That is, a wire is connected outside of both the upper trunk and the lower trunk. After the upper trunk is connected to the lower trunk, a wire of the upper trunk is connected to a wire of the lower trunk later. This method has a troublesome operation and an unsightly appearance.

### SUMMARY

### (1) Technical Problems to be Solved

In view of the disadvantage in the prior art, this application provides an electrically conductive connecting assembly of a Christmas tree trunk that may solve above-mentioned technical problems.

### (2) Technical Solution

To solve the above-mentioned technical problems, the technical solution of the present application is provided as follows.

An electrically conductive connecting assembly of a Christmas tree trunk, including:
an upper trunk, wherein a first receiving slot is provided in a bottom end of the upper trunk along a length direction of the upper trunk;
a lower trunk, wherein a second receiving slot configured to detachably accommodate the bottom end of the upper trunk is provided in a top end of the lower trunk along a length direction of the lower trunk;
a first electrically conductive head provided in the first receiving slot of the upper trunk, wherein the first electrically conductive head includes a first insulating housing, a first wire, a second wire, an insulator, a first electrical conductor and a second electrical conductor; the first insulating housing is provided in the first receiving slot, the insulator extends to an outside of the first insulating housing from the first insulating housing; the first electrical conductor and the second electrical conductor are located at one end of the insulator away from the first insulating housing, and the first electrical conductor is provided around an outside of the second electrical conductor; the first wire and the second wire are accommodated in the first insulating housing and electrically connected to the first electrical conductor and the second electrical conductor respectively;
a second electrically conductive head provided in the second receiving slot of the lower trunk; wherein the second electrically conductive head includes a second insulating housing, a third wire, a fourth wire, a third electrical conductor and a fourth electrical conductor; the second insulating housing is provided in the second receiving slot, the third electrical conductor and the fourth electrical conductor are provided in the second insulating housing at intervals and electrically connected to the third wire and the fourth wire located in the second insulating housing respectively;
when the bottom end of the upper trunk is inserted in the second receiving slot, the first electrical conductor is electrically connected to the third electrical conductor, the second electrical conductor is electrically connected to the fourth electrical conductor.

Furthermore, the insulator is in a long cylindrical shape, a first extension portion in a cylindrical shape is extendingly provided on the other end of the insulator, the first electrical conductor is in an annular shape and sleeved on an outside of the first extension portion, the second electrical conductor is in a long cylindrical shape, the second electrical conductor is provided on one end of the first extension portion away from the insulator, both the third electrical conductor and the fourth electrical conductor are in annular shape, when the bottom end of the upper trunk is inserted in the second receiving slot, the first electrical conductor is inserted in the third electrical conductor and electrically connected to the third electrical conductor, the second electrical conductor is inserted in the fourth electrical conductor and electrically connected to the fourth electrical conductor.

Furthermore, an outer diameter of the insulator is larger than an outer diameter of the first extension portion, the outer diameter of the insulator is larger than an outer diameter of the first electrical conductor, the outer diameter of the first extension portion is larger than an outer diameter of the second electrical conductor, the outer diameter of the first electrical conductor is equal to an inner diameter of the third electrical conductor, the outer diameter of the second electrical conductor is equal to an inner diameter of the fourth electrical conductor.

Furthermore, a first clamping slot is provided in one end of the first insulating housing, one end of the insulator is accommodated in the first clamping slot, a second clamping slot and a third clamping slot are provided at intervals in one end of the second insulating housing along a length direction of the second insulating housing, wherein the third electrical conductor is accommodated in the second clamping slot, the fourth electrical conductor is accommodated in the third clamping slot.

Furthermore, a limiting clamping slot in an annular shape is extendingly provided on an inner wall of the first clamping slot of the first insulating housing, a protruding portion in an annular shape and accommodated in the limiting clamping slot is provided on the insulator, wherein a length of the protruding portion is shorter than a length of the limiting clamping slot.

Furthermore, a spring is accommodated in the first clamping slot of the first insulating housing, the one end of the insulator passes through the spring, one end of the spring is provided on a bottom wall of the first clamping slot of the first insulating housing, the other end of the spring is supported on the protruding portion.

Furthermore, a distance between an end portion of the one end of the insulator and the protruding portion is shorter than a length of the spring in a normal situation.

Additionally, to solve the above-mentioned technical problems, the present application also provides the technical solution as follows:

An electrically conductive connecting assembly of a Christmas tree trunk, including:
an upper trunk, wherein a first receiving slot is provided in a bottom end of the upper trunk along a length direction of the upper trunk;
a lower trunk, wherein a second receiving slot configured to detachably accommodate the bottom end of the upper trunk is provided in a top end of the lower trunk along a length direction of the lower trunk;
a first electrically conductive head provided in the first receiving slot of the upper trunk;
a second electrically conductive head provided in the second receiving slot of the lower trunk;
wherein, when the bottom end of the upper trunk is inserted in the second receiving slot, the first electrically conductive head is electrically connected to the second electrically conductive head;
the first electrically conductive head includes a first insulating housing provided in the first receiving slot, a first wire and a second wire accommodated in the first insulating housing, an insulator of which one end is accommodated in the first insulating housing and the other end is located on an outside of the first insulating housing, a first electrical conductor provided on the other end of the insulator and electrically connected to the first wire, and a second electrical conductor provided on the other end of the insulator and electrically connected to the second wire, wherein the first electrical conductor and the second electrical conductor are provided at intervals;
the second electrically conductive head includes a second insulating housing provided in the second receiving slot, a third wire and a fourth wire accommodated in the second insulating housing, a third electrical conductor provided in the second insulating housing and electrically connected to the third wire, and a fourth electrical conductor provided in the second insulating housing and electrically connected to the fourth wire, wherein the third electrical conductor and the fourth electrical conductor are provided at intervals;
wherein, when the bottom end of the upper trunk is inserted in the second receiving slot, the first electrical conductor is electrically connected to the third electrical conductor, the second electrical conductor is electrically connected to the fourth electrical conductor;
the insulator is in a long cylindrical shape, wherein a first extension portion in a cylindrical shape is extendingly provided on the other end of the insulator, the first electrical conductor is in an annular shape and sleeved on an outside of the first extension portion, the second electrical conductor is in a long cylindrical shape, the second electrical conductor is provided on one end of the first extension portion away from the insulator, both the third electrical conductor and the fourth electrical conductor are in annular shape, when the bottom end of the upper trunk is inserted in the second receiving slot, the first electrical conductor is inserted in the third electrical conductor and electrically connected to the third electrical conductor, the second electrical conductor is inserted in the fourth electrical conductor and electrically connected to the fourth electrical conductor;
a first clamping slot is provided in one end of the first insulating housing, the one end of the insulator is accommodated in the first clamping slot, a second clamping slot and a third clamping slot are provided at intervals in one end of the second insulating housing along a length direction of the second insulating housing, wherein the third electrical conductor is accommodated in the second clamping slot, the fourth electrical conductor is accommodated in the third clamping slot.

### (3) Beneficial Effects

Compared with the prior art, the present application provides the electrically conductive connecting assembly of a Christmas tree trunk with following beneficial effects: the electrically conductive connecting assembly of a Christmas tree trunk disclosed by the present application includes: an upper trunk, wherein a first receiving slot is provided in a bottom end of the upper trunk along a length direction of the upper trunk; a lower trunk, wherein a second receiving slot configured to detachably accommodate the bottom end of the upper trunk is provided in a top end of the lower trunk along a length direction of the lower trunk; a first electrically conductive head provided in the first receiving slot of the upper trunk; a second electrically conductive head provided in the second receiving slot of the lower trunk; wherein, when the bottom end of the upper trunk is inserted in the second receiving slot, the first electrically conductive head is electrically connected to the second electrically conductive head. By above-mentioned method, the present application enables an electrical connection between the first electrically conductive head in the upper trunk and the second electrically conductive head in the lower trunk when the upper trunk is connected to the lower trunk, without any exposed wires. This offers a pleasing appearance and simple operation, and meanwhile it can be rotated 360 degrees after electricity is conducted, providing a better practical effect.

### BRIEF DESCRIPTION

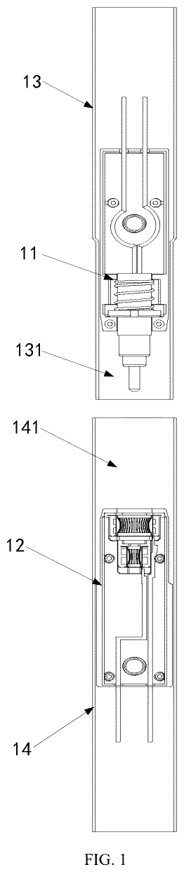

FIG. 1 is a schematic structural diagram of an electrically conductive connecting assembly of a Christmas tree trunk of the present application;

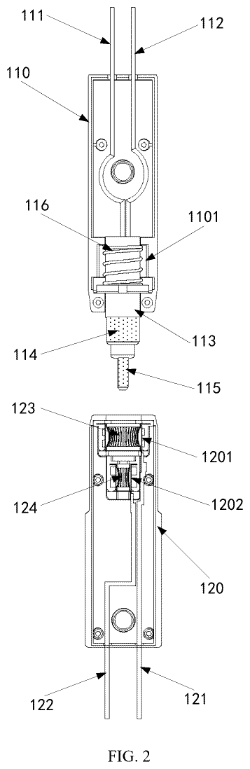

FIG. 2 is a schematic structural diagram of a first electrically conductive head and a second electrically conductive head in FIG. 1;

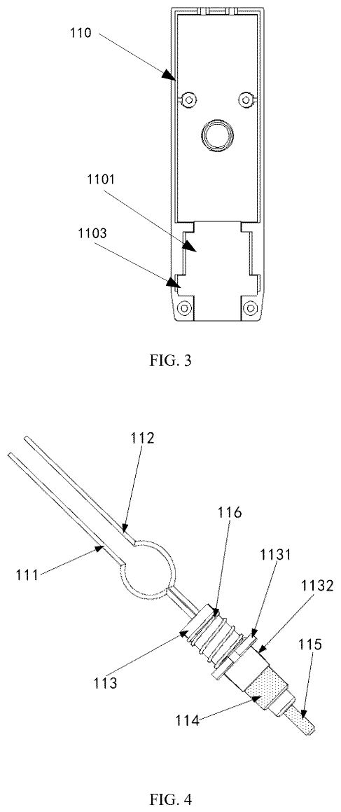

FIG. 3 is a schematic structural diagram of a first insulating housing of the first electrically conductive head in FIG. 2; and

FIG. 4 is a partial schematic structural diagram of the first electrically conductive head in FIG. 2.

### DETAILED DESCRIPTION

The solutions of the present application will be described clearly and completely in conjunction with drawings. Apparently, the embodiments described are part, not all, of the embodiments of the present application. Based on the embodiments in the present application, all other embodiments obtained by those of ordinary skill in the art without creative work are within the scope of the present application.

Please refer to FIGS. 1-4. The electrically conductive connecting assembly of a Christmas tree trunk according to this application includes a first electrically conductive head 11, a second electrically conductive head 12, an upper trunk 13 and a lower trunk 14.

A first receiving slot 131 is provided in a bottom end of the upper trunk 13 along a length direction of the upper trunk 13.

A second receiving slot 141 configured to detachably accommodate the bottom end of the upper trunk 13 is provided in a top end of the lower trunk 14 along a length direction of the lower trunk 14. That is to say, the bottom end of the upper trunk 13 may be inserted in the second receiving slot 141 of the lower trunk 14, and may be pulled out from the second receiving slot 141.

Specifically, the upper trunk 13 is in a long cylindrical shape, the second receiving slot 141 is in a circular shape. Wherein, an outer diameter of the upper trunk 13 is equal to or slightly less than (e.g., less than 1-2 mm) an inner diameter of the second receiving slot 141.

The first electrically conductive head 11 is provided in the first receiving slot 131 of the upper trunk 13.

The second electrically conductive head 12 is provided in the second receiving slot 141 of the lower trunk 14.

In this embodiment, when the bottom end of the upper trunk 13 is inserted in the second receiving slot 141, the first electrically conductive head 11 is electrically connected to the second electrically conductive head 12.

It is worth noting that, a clamping portion configured to clamp the upper trunk 13 is provided in an inner wall of the second receiving slot 141. This makes a gravity of the upper trunk 13 not be applied to the second electrically conductive head 12, rather, the first electrically conductive head 11 is just electrically connected to the second electrically conductive head 12, when the bottom end of the upper trunk 13 is inserted in the second receiving slot 141.

In this embodiment, the first electrically conductive head 11 includes a first insulating housing 110 provided in the first receiving slot 131, a first wire 111 and a second wire 112 accommodated in the first insulating housing 110, an insulator 113 of which one end is accommodated in the first insulating housing 110 and the other end is located on an outside of the first insulating housing 110, a first electrical conductor 114 provided on the other end of the insulator 113 and electrically connected to the first wire 111, and a second electrical conductor 115 provided on the other end of the insulator 113 and electrically connected to the second wire 112. Wherein, the first electrical conductor 114 and the second electrical conductor 115 are provided at intervals.

Preferably, the insulator 113 is in a long cylindrical shape. Wherein, a first extension portion 1132 in a cylindrical shape is extendingly provided on the other end of the insulator 113, the first electrical conductor 114 is in an annular shape and sleeved on an outside of the first extension portion 1132, the second electrical conductor 115 is in a long cylindrical shape, and the second electrical conductor 115 is provided on one end of the first extension portion 1132 away from the insulator 113.

Preferably, an outer diameter of the insulator 113 is larger than an outer diameter of the first extension portion 1132, the outer diameter of the insulator 113 is larger than an outer diameter of the first electrical conductor 114, the outer diameter of the first extension portion 1132 is larger than an outer diameter of the second electrical conductor 115.

In this embodiment, the second electrically conductive head 12 includes a second insulating housing 120 provided in the second receiving slot 141, a third wire 121 and a fourth wire 122 accommodated in the second insulating housing 120, a third electrical conductor 123 provided in the second insulating housing 120 and electrically connected to the third wire 121, and a fourth electrical conductor 124 provided in the second insulating housing 120 and electrically connecting to the fourth wire 122. Wherein, the third electrical conductor 123 and the fourth electrical conductor 124 are provided at intervals.

Preferably, when the bottom end of the upper trunk 13 is inserted in the second receiving slot 141, the first electrical conductor 114 is electrically connected to the third electrical conductor 123, and the second electrical conductor 115 is electrically connected to the fourth electrical conductor 124.

Preferably, both the third electrical conductor 123 and the fourth electrical conductor 124 are in annular shape. Furthermore, the outer diameter of the first electrical conductor 114 is equal to an inner diameter of the third electrical conductor 123, the outer diameter of the second electrical conductor 115 is equal to an inner diameter of the fourth electrical conductor 124.

It should be understood that, when the bottom end of the upper trunk 13 is inserted in the second receiving slot 141, the first electrical conductor 114 is inserted in the third electrical conductor 123 and electrically connected to the third electrical conductor 123, the second electrical conductor 115 is inserted in the fourth electrical conductor 124 and electrically connected to the fourth electrical conductor 124. That is to say, when the bottom end of the upper trunk 13 is inserted in the second receiving slot 141 and clamped by the clamping portion, the first electrical conductor 114 is just inserted in the third electrical conductor 123 and the second electrical conductor 115 is just inserted in the fourth electrical conductor 124.

In this embodiment, a first clamping slot 1101 is provided in one end of the first insulating housing 110. The one end of the insulator 113 is accommodated in the first clamping slot 1101. A second clamping slot 1201 and a third clamping slot 1202 are provided at intervals on one end of the second insulating housing 120 along a length direction of the second insulating housing 120 (the third clamping slot 1202 is provided along a direction away from the first electrically conductive head 11). Wherein, the third electrical conductor 123 is accommodated in the second clamping slot 1201, the fourth electrical conductor 124 is accommodated in the third clamping slot 1202.

Furthermore, a limiting clamping slot 1103 in an annular shape is extendingly provided on an inner wall of the first clamping slot 1101 of the first insulating housing 110. A protruding portion 1131 in an annular shape and accommodated in the limiting clamping slot 1103 is provided in the insulator 113. Wherein, a length of the protruding portion 1131 (that is, a length along a length direction of the insulator 113) is smaller than a length of the limiting clamping slot 1103, thus enabling the protruding portion 1131 to slide in the limiting clamping slot 1103. It should be understood, that an aperture of the limiting clamping slot 1103 is larger than an aperture of the first clamping slot 1101, an outer diameter of the protruding portion 1131 is larger than the aperture of the first clamping slot 1101, and the outer diameter of the protruding portion 1131 is smaller than the aperture of the limiting clamping slot 1103.

Additionally, a spring 116 is accommodated in the first clamping slot 1101 of the first insulating housing 110. Wherein, the one end of the insulator 113 passes through the spring 116, and one end of the spring 116 is provided on a bottom wall of the first clamping slot 1101 of the first insulating housing 110, the other end of the spring 116 is supported in the protruding portion 1131.

Preferably, a distance between an end portion of the one end of the insulator 113 and the protruding portion 1131 is smaller than a length of the spring 116 in a normal situation. This enables the spring 116 to have a cushioning effect on the insulator 113 in the normal situation, making the insulator 113 drive the first electrical conductor 114 and the second electrical conductor 115 to extend or retract, and thus having a protection function.

Additionally, since the first electrical conductor 114 is in the annular shape, the second electrical conductor 115 is in the long cylindrical shape, both the third electrical conductor 123 and the fourth electrical conductor 124 are in the annular shape, when the bottom end of the upper trunk 13 is inserted in the second receiving slot 141, the upper trunk 13 and the lower trunk 14 may be rotated, which is convenient to rotate a top of the Christmas tree and providing a better practical effect.

It should be noted that, terms “include”, “comprise” or any other variants are intended to be non-exclusive. Therefore, a process, method, article or device including multiple elements includes not only the elements but also other elements that are not enumerated, or also include the elements inherent for the process, method, article or device. Unless expressively limited otherwise, the statement “comprising (including) a . . . ” does not exclude other similar elements that may exist in the process, method, article or device including the elements.

Although specific embodiments of the present disclosure have been shown and described, for those ordinarily skilled in the art, it could be understood that various changes, amendments, substitutions, and modifications could be made to these specific embodiments without departing from the principle and spirit of the present disclosure, and the scope of the present disclosure is defined by the appended claims and their equivalents.

What is claimed:

1. An electrically conductive connecting assembly of a Christmas tree trunk, comprising:
an upper trunk, wherein a first receiving slot is provided in a bottom end of the upper trunk along a length direction of the upper trunk;
a lower trunk, wherein a second receiving slot configured to detachably accommodate the bottom end of the upper trunk is provided in a top end of the lower trunk along a length direction of the lower trunk;
a first electrically conductive head provided in the first receiving slot of the upper trunk, wherein the first electrically conductive head includes a first insulating housing, a first wire, a second wire, an insulator, a first electrical conductor and a second electrical conductor; the first insulating housing is provided in the first receiving slot, the insulator extends to an outside of the first insulating housing from the first insulating housing; the first electrical conductor and the second electrical conductor are located at one end of the insulator away from the first insulating housing, and the first electrical conductor is provided around an outside of the second electrical conductor; the first wire and the second wire are accommodated in the first insulating housing and electrically connected to the first electrical conductor and the second electrical conductor respectively;
a second electrically conductive head provided in the second receiving slot of the lower trunk; wherein the second electrically conductive head includes a second insulating housing, a third wire, a fourth wire, a third electrical conductor and a fourth electrical conductor; the second insulating housing is provided in the second receiving slot, the third electrical conductor and the fourth electrical conductor are provided in the second insulating housing at intervals and electrically connected to the third wire and the fourth wire located in the second insulating housing respectively;
wherein, when the bottom end of the upper trunk is inserted in the second receiving slot, the first electrical conductor is electrically connected to the third electrical conductor, the second electrical conductor is electrically connected to the fourth electrical conductor.

2. The electrically conductive connecting assembly of a Christmas tree trunk of claim 1, wherein, the insulator is in a long cylindrical shape, a first extension portion in a cylindrical shape is extendingly provided on the other end of the insulator, the first electrical conductor is in an annular shape and sleeved on an outside of the first extension portion, the second electrical conductor is in a long cylindrical shape, the second electrical conductor is provided on one end of the first extension portion away from the insulator, both the third electrical conductor and the fourth electrical conductor are in annular shape, when the bottom end of the upper trunk is inserted in the second receiving slot, the first electrical conductor is inserted in the third electrical conductor and electrically connected to the third electrical conductor, the second electrical conductor is inserted in the fourth electrical conductor and electrically connected to the fourth electrical conductor.

3. The electrically conductive connecting assembly of a Christmas tree trunk of claim 2, wherein, an outer diameter of the insulator is larger than an outer diameter of the first extension portion, the outer diameter of the insulator is larger than an outer diameter of the first electrical conductor, the outer diameter of the first extension portion is larger than an outer diameter of the second electrical conductor, the outer diameter of the first electrical conductor is equal to an inner diameter of the third electrical conductor, the outer diameter of the second electrical conductor is equal to an inner diameter of the fourth electrical conductor.

4. The electrically conductive connecting assembly of a Christmas tree trunk of claim 1, wherein, a first clamping slot is provided in one end of the first insulating housing, one end of the insulator is accommodated in the first clamping slot, a second clamping slot and a third clamping slot are provided at intervals in one end of the second insulating housing along a length direction of the second insulating housing, wherein the third electrical conductor is accommodated in the second clamping slot, the fourth electrical conductor is accommodated in the third clamping slot.

5. The electrically conductive connecting assembly of a Christmas tree trunk of claim 4, wherein, a limiting clamping slot in an annular shape is extendingly provided on an inner wall of the first clamping slot of the first insulating housing, a protruding portion in an annular shape and accommodated in the limiting clamping slot is provided on the insulator, wherein a length of the protruding portion is shorter than a length of the limiting clamping slot.

6. The electrically conductive connecting assembly of a Christmas tree trunk of claim 5, wherein, a spring is accommodated in the first clamping slot of the first insulating housing, the one end of the insulator passes through the spring, one end of the spring is provided on a bottom wall of the first clamping slot of the first insulating housing, the other end of the spring is supported on the protruding portion.

7. The electrically conductive connecting assembly of a Christmas tree trunk of claim 6, wherein, a distance between an end portion of the one end of the insulator and the protruding portion is shorter than a length of the spring in a normal situation.

8. An electrically conductive connecting assembly of a Christmas tree trunk, comprising:
an upper trunk, wherein a first receiving slot is provided in a bottom end of the upper trunk along a length direction of the upper trunk;
a lower trunk, wherein a second receiving slot configured to detachably accommodate the bottom end of the upper trunk is provided in a top end of the lower trunk along a length direction of the lower trunk;
a first electrically conductive head provided in the first receiving slot of the upper trunk;
a second electrically conductive head provided in the second receiving slot of the lower trunk;
wherein, when the bottom end of the upper trunk is inserted in the second receiving slot, the first electrically conductive head is electrically connected to the second electrically conductive head;
the first electrically conductive head includes a first insulating housing provided in the first receiving slot, a first wire and a second wire accommodated in the first insulating housing, an insulator of which one end is accommodated in the first insulating housing and the other end is located on an outside of the first insulating housing, a first electrical conductor provided on the other end of the insulator and electrically connected to the first wire, and a second electrical conductor provided on the other end of the insulator and electrically connected to the second wire, wherein the first electrical conductor and the second electrical conductor are provided at intervals;
the second electrically conductive head includes a second insulating housing provided in the second receiving slot, a third wire and a fourth wire accommodated in the second insulating housing, a third electrical conductor provided in the second insulating housing and electrically connected to the third wire, and a fourth electrical conductor provided in the second insulating housing and electrically connected to the fourth wire, wherein the third electrical conductor and the fourth electrical conductor are provided at intervals;
wherein, when the bottom end of the upper trunk is inserted in the second receiving slot, the first electrical conductor is electrically connected to the third electrical conductor, the second electrical conductor is electrically connected to the fourth electrical conductor;
the insulator is in a long cylindrical shape, wherein a first extension portion in a cylindrical shape is extendingly provided on the other end of the insulator, the first electrical conductor is in an annular shape and sleeved on an outside of the first extension portion, the second electrical conductor is in a long cylindrical shape, the second electrical conductor is provided on one end of the first extension portion away from the insulator, both the third electrical conductor and the fourth electrical conductor are in annular shape, when the bottom end of the upper trunk is inserted in the second receiving slot, the first electrical conductor is inserted in the third electrical conductor and electrically connected to the third electrical conductor, the second electrical conductor is inserted in the fourth electrical conductor and electrically connected to the fourth electrical conductor;
a first clamping slot is provided in one end of the first insulating housing, the one end of the insulator is accommodated in the first clamping slot, a second clamping slot and a third clamping slot are provided at intervals in one end of the second insulating housing along a length direction of the second insulating housing, wherein the third electrical conductor is accommodated in the second clamping slot, the fourth electrical conductor is accommodated in the third clamping slot.
